(19) United States
(12) Patent Application Publication
(10) Pub. No.: US 2015/0280242 A1
(43) Pub. Date: Oct. 1, 2015

(54) NONAQUEOUS-ELECTROLYTE SECONDARY BATTERY

(71) Applicant: KABUSHIKI KAISHA TOYOTA JIDOSHOKKI, Kariya-shi, Aichi (JP)

(72) Inventors: Tatsuya Eguchi, Kariya-shi (JP); Takeshi Maki, Kariya-shi (JP)

(73) Assignee: KABUSHIKI KAISHA TOYOTA JIDOSHOKKI, Kariya-shi, Aichi (JP)

(21) Appl. No.: 14/440,384

(22) PCT Filed: Nov. 5, 2013
(86) PCT No.: PCT/JP2013/006523

§ 371 Date: May 4, 2015

(30) Foreign Application Priority Data
Nov. 12, 2012 (JP) 2012-248647

(51) Int. Cl. H01M 4/66; H01M 4/52; H01M 4/62; H01M 10/052; H01M 10/0568; H01M 4/505; H01M 4/525

(52) U.S. Cl. CPC H01M 4/667; H01M 4/505; H01M 4/523; H01M 4/525; H01M 10/052; H01M 10/0568; H01M 4/623; H01M 4/625; H01M 2004/028

(57) ABSTRACT

Providing a nonaqueous-electrolyte secondary battery exhibiting superior rate characteristic and cyclability even under high-voltage application environments.

The nonaqueous-electrolyte secondary battery includes: a positive-electrode current collector for nonaqueous-electrolyte secondary battery including: a current-collector body; and a film formed on a surface of the current-collector body, and composed of SnO₂, a conductive carbon material and a binder for film; and a nonaqueous electrolyte containing LiPF₆ (i.e., lithium hexafluorophosphate) as an electrolytic salt.

### TECHNICAL FIELD

The present invention relates to a nonaqueous-electrolyte secondary battery.

### BACKGROUND ART

For the positive-electrode current collector of a nonaqueous-electrolyte secondary battery, employing a metal, such as Al forming a stable passivation film on the surface, has been common in order to endure corrosions resulting from electrolytic salts, and the like. For example, when using Al in a current collector, passivation films of Al₂O₃, AlF₃, and so forth, are formed on a surface of the Al current collector. Forming the aforementioned passivation films on the surface leads to making the Al current collector less likely to be corroded, thereby enabling the Al current collector to keep the current collecting function.

In recent years, nonaqueous-electrolyte secondary batteries have been desired to be employable satisfactorily even under high-voltage application environments (note that employing nonaqueous-electrolyte secondary batteries with a voltage 4.3 V or more is defined as the “high-voltage application” in the present description). Moreover, a requirement for making nonaqueous-electrolyte secondary batteries exhibit high capacities even under high-voltage application environments has been heightening. In the aforementioned Al current collector, corrosions are likely to take place gradually under high-voltage application environments, so that a nonaqueous-electrolyte secondary battery comprising the Al current collector is probably associated with such a concern that the cyclability declines.

LiPF₆ (i.e., lithium hexafluorophosphate) serving as the electrolytic salt of a nonaqueous-electrolyte secondary battery has been said to be less likely to corrode Al. However, Al is probably associated with a fear of being eluted under high-voltage application environments.

Investigations for forming protective films on current collectors have been carried out in order to raise the cyclabilities under high-voltage application environments. For example, Patent Application Publication No. 1 (i.e., Japanese Unexamined Patent Publication (KOKAI) Gazette No. 2004-55247) sets forth a current collector on which a protective film is formed. The protective film includes, as a constituent element, a compound selected from the group including aluminum iodide, TiN, Ti₂O₃, SnO₂, In₂O₃, RuO₂, and the like. The protective film is constituted of a compound being stable electrochemically even under high voltages. However, Patent Application Publication No. 1 sets forth only the following: the maintained-capacity rates (%) and recovered-capacity rates (%) of batteries after being left at 50° C. for two weeks; and the cyclabilities (%) of the batteries after being subjected to a 300-cycle test at 50° C., but does not set forth the rate characteristics thereof at all.

Moreover, investigations for forming conductive layers on current collectors have also been carried out in order to improve the output characteristics under high-voltage application environments.

Patent Application Publication No. 2 (i.e., Japanese Unexamined Patent Publication (KOKAI) Gazette No. 2011-96667) sets forth a positive-electrode current collector comprising: a passivation film arranged on a surface of the current collector made of aluminum or an aluminum alloy, the passivation film having a thickness set at 3 nm or less; and a conductive layer formed further on the passivation film, the conductive layer composed of a metal or metallic carbide. In examples according to Patent Application Publication No. 2, the capacities of batteries arising from each of predetermined discharge rates were measured: Patent Application Publication No. 2 sets forth that forming the conductive layer results in upgrading the capacities of the batteries at a rate of 50 C or more. However, in Patent Application Publication No. 2, the cyclabilities of the batteries were not evaluated at all. Moreover, Patent Application Publication No. 2 sets forth that the capacities of the batteries according to Second through Seventh Testing Examples employing as the current collector an aluminum film on which the conductive layer was formed had capacities all of which were low at such rates as (⅓)C, 1 C and 5 C, compared with the capacities of the battery according to First Testing Example employing as the current collector an untreated aluminum foil.

### PATENT LITERATURE

Patent Application Publication No. 1: Japanese Unexamined Patent Publication (KOKAI) Gazette No. 2004-55247; and

Patent Application Publication No. 2: Japanese Unexamined Patent Publication (KOKAI) Gazette No. 2011-96667

### SUMMARY OF THE INVENTION

### Technical Problem

The present invention is made in view of such circumstances. An object of the present invention is to provide a nonaqueous-electrolyte secondary battery exhibiting superior rate characteristic and cyclability in compatible with each other even under high-voltage application environments.

### Solution to Problem

As a result of wholehearted investigations by the present inventors, the present inventors found out that forming a film composed of SnO₂, a conductive carbon material and a binder for film on the surface of a current-collector body for positive electrode, and using a nonaqueous electrolyte containing LiPF₆ (i.e., lithium hexafluorophosphate) as an electrolytic salt lead to a nonaqueous-electrolyte secondary battery exhibiting superior rate characteristic and cyclability in compatible with each other even under high-voltage application environments.

That is, a nonaqueous-electrolyte secondary battery according to the present invention comprises:

a positive-electrode current collector for nonaqueous-electrolyte secondary battery, the positive-electrode current collector including: a current-collector body; and a film formed on a surface of the current-collector body, and composed of SnO₂, a conductive carbon material and a binder for film; and

a nonaqueous electrolyte containing LiPF₆ (i.e., lithium hexafluorophosphate) as an electrolytic salt.

A preferable mixed ratio between the SnO₂ and the conductive carbon material is from 75:25 to 25:75 by mass.

In particular, the nonaqueous-electrolyte secondary battery according to the present invention preferably further comprises a positive-electrode active material including a composite metallic oxide expressed by a general formula: LiCoₚNi_{q}MnᵣDₛO₂ (where “D” is a doped component, and is at least one member selected from the group consisting of Al, Mg, Ti, Sn, Zn, W, Zr, Mo, Fe, and Na; “p”+“q”+“r”+“s”=1; 0≦“p”≦1; 0≦“q”≦1; 0≦“r”≦1; and 0≦“s”<1). Note herein that the aforementioned “p,” “q,” and “r” are preferably set in such a range as 0<“p”<1, 0<“q”<1, and 0<“r”<1, respectively.

A preferable thickness of the film is from 10 nm to 1 μm.

### Advantageous Effects of the Invention

In the nonaqueous-electrolyte secondary battery according to the present invention, since a nonaqueous electrolyte containing LiPF₆ (i.e., lithium hexafluorophosphate) as an electrolytic salt is used, and since a film composed of SnO₂ with high oxidation resistance and high corrosion resistance, a conductive carbon material and a binder for film is formed, the present invention enables a nonaqueous-electrolyte secondary battery to excel in both of the rate characteristic and the cyclability even when used under high-voltage application environments.

### BRIEF DESCRIPTION OF THE DRAWINGS

FIG. 1 is a schematic diagram explaining a positive electrode for nonaqueous-electrolyte secondary battery according to one of the present examples;

FIG. 2 is a graph expressing the results of measuring the rate characteristics of First through Third Examples and First through Third Comparative Examples; and

FIG. 3 is a graph expressing the results of measuring the cyclabilities of First through Third Examples and First through Third Comparative Examples.

### EXPLANATION ON REFERENCE NUMERALS

1: Current-collector Body;
2: Film;
3: Positive-electrode Active-material Layer; and
4: Positive-electrode Current Collector for Nonaqueous-electrolyte Secondary Battery

### DESCRIPTION OF THE EXAMPLES

### Nonaqueous-Electrolyte Secondary Battery

A nonaqueous-electrolyte secondary battery according to the present invention comprises a positive-electrode current collector for nonaqueous-electrolyte secondary battery, and a nonaqueous electrolyte. The positive-electrode current collector includes a current-collector body, and a film formed on a surface of the current-collector body and composed of SnO₂, a conductive carbon material and a binder for film. The nonaqueous electrolyte contains LiPF₆ (i.e., lithium hexafluorophosphate) as an electrolytic salt.

### Positive-Electrode Current Collector for Nonaqueous-Electrolyte Secondary Battery

The “current-collector body” refers to a chemically inactive high electron conductor for keeping an electric current flowing to electrodes during discharging or charging a nonaqueous-electrolyte secondary battery. Since the positive-electrode current collector for nonaqueous-electrolyte secondary battery according to the present invention comprises a film formed on a surface of the current-collector body, enduring corrosions resulting from electrolytic salts, and the like, is possible for the current-collector body. Consequently, as a material usable for the current-collector body, giving the following is possible, for instance: metallic materials, such as stainless steels, titanium, nickel, aluminum and copper; or electrically-conductive resins. Moreover, for the current-collector body, taking on forms, such as foils, sheets and films, is possible. Consequently, as the current-collector body, metallic foils, such as copper foils, nickel foils, aluminum foils and stainless-steel foils, are usable suitably, for instance.

A preferable thickness of the current-collector body is from 10 μm to 100 μm.

When an aluminum foil is used as the current-collector body, passivation films of Al₂O₃, AlF₃, and the like, are usually formed on a surface of the current-collector body: the Al₂O₃ are formed by the spontaneous reaction with oxygen in the air; and the AlF₃ is formed by reactions with electrolytic salts in electrolytic solutions. The passivation films are insulators, and the specific resistances (Ωcm) are on the order of 10⁸ by the number of digits. The following have been said: the aluminum film is protected from electrolytic salts by the passivation films; however, an electrode using a current collector having the passivation films on the surface becomes highly resistant because the passivation films are films with a high resistance; and accordingly a battery using the electrode exhibits declined output characteristics.

Since the positive-electrode current collector for nonaqueous-electrolyte secondary battery according to the present invention comprises a film formed on a surface of the current-collector body, the aforementioned passivation films are less likely to be formed. Consequently, the film is able to inhibit high-resistance layers from being formed on a surface of the current-collector body, and is able to save the current-collector body from being corroded by electrolytic salts, and so on.

A preferable thickness of the film is from 10 nm to 1 μm, and a more preferable thickness thereof is from 20 nm to 500 nm. When the thickness of the film is 10 nm or more, the filmprotects a surface of the current-collector body, and accordingly inhibits the current-collector body from being corroded by electrolytic solutions. When the thickness of the film is 1 μm or less, a volume occupied by the positive-electrode current collector within a battery is suitable. Too large a volume occupied by the positive-electrode current collector within a battery is not preferable, because a positive-electrode active material needs to be reduced in the amount, and the like, thereby leading to declining the battery in the capacities.

Moreover, the film is composed of SnO₂, a conductive carbon material, and a binder for film.

The SnO₂ has resistance to oxygen in the air, electrolytic solutions and electrolytic salts, and additionally the resistance is demonstrated even at high voltages. Moreover, since the SnO₂ excels in the oxidation resistance and further excels in the corrosion resistance, the SnO₂ has an advantageous effect on upgrading cyclability.

As the SnO₂, a powder having an average particle diameter of from 10 nm to 100 nm is usable.

The conductive carbon material is a material giving conductivity to the film. As the conductive carbon material, the following are employable independently, or two or more of the following are combinable to employ: carbonaceous fine particles, such as carbon black, graphite, acetylene black (or AB) and KETJENBLACK (or KB (registered trademark)); and gas-phase-method carbon fibers (i.e., vapor-grown carbon fibers (or VGCF)).

The binder for film performs a role of binding the SnO₂ and conductive carbon material together on the current-collector body. An employable binder for film is the same as binders having been usually used to bind a positive-electrode active material together on the current-collector body. As the binder for film, the following are usable, for instance: fluorine-containing resins, such as polyvinylidene fluoride, polytetrafluoroethylene and fluorinated rubber; thermoplastic resins, such as polypropylene, polyethylene and polyvinyl acetate-based resins; imide-based resins, such as polyimide and polyamide-imide; and alkoxysilyl group-containing resins; as well as rubbers, such as styrene-butadiene rubber (or SBR).

In the film, a preferable mixed ratio between the SnO₂ and the conductive carbon material is from 75:25 to 25:75 by mass. When a content of the conductive carbon material is great, the rate characteristic of the present nonaqueous-electrolyte secondary battery upgrades. Moreover, when a content of the SnO₂ is great, the cyclability of the present nonaqueous-electrolyte secondary battery upgrades. Therefore, using an optimum mixed ratio is allowable depending on conditions under which employing the present nonaqueous-electrolyte secondary battery is desired.

Moreover, the film formed on a surface of the current-collector body functions as a resistant layer. For example, when short-circuiting occurs in the present nonaqueous-electrolyte secondary battery, the film restricts currents from flowing.

Although a method for forming the film onto the current-collector body is not limited especially, the film is formable by the following method.

A powder of the SnO₂, the conductive carbon material, and the binder for film are dissolved in an organic solvent or water for viscosity adjustment, thereby preparing a paste-like mixture. The paste-like mixture is coated on the current-collector body, and is dried after the coating. As for the coating method, publicly-known conventional methods, such as roll coating methods, dip coating methods, doctor blade methods, spray coating methods and curtain coating methods, are allowed to use.

As the solvent for viscosity adjustment, ethanol, N-methyl-2-pyrrolidone (or NMP), methanol, methyl isobutyl ketone (or MIBK), and the like, are employable. Water with impurities removed, such as distilled water or ion-exchanged water, is preferable.

Moreover, the film is also formable onto the current-collector body even by the following method. A powder of the SnO₂, the conductive carbon material, and the binder for film are dissolved in an organic solvent or water, thereby preparing a solution. The solution is sprayed to a coating surface of the current-collector body using a sprayer. The organic solvent is then volatilized to remove, thereby forming the film on the current-collector body. A preferable binder for film in such a case is dissolved in the organic solvent and solidified when the organic solvent has volatilized. For example, the following are employable: thermoplastic resins, such as polyvinyl acetate-based resins, or rubbers. For the organic solvent in such a case, ethanol, NMP, methanol, or MIBK, and the like, is employable. Water with impurities removed, such as distilled water or ion-exchanged water, is preferable.

### Positive Electrode for Nonaqueous-Electrolyte Secondary Battery

A nonaqueous-electrolyte secondary battery according to the present invention comprises a positive electrode including the aforementioned positive-electrode current collector for nonaqueous-electrolyte secondary battery.

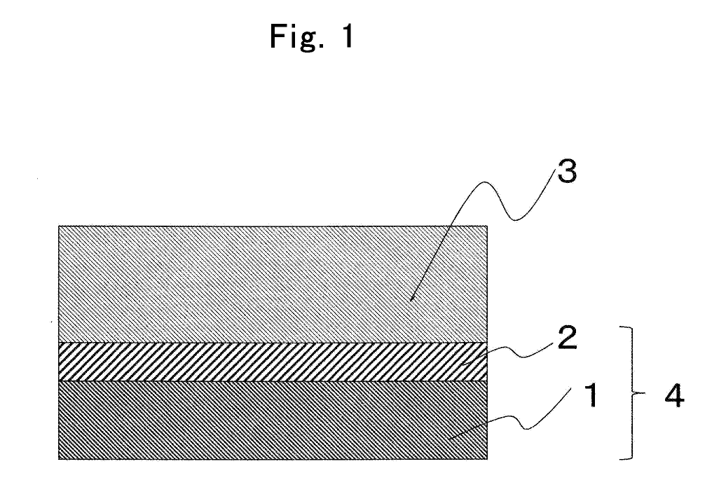

The positive electrode is made by adhering a positive-electrode active-material layer on the aforementioned positive-electrode current collector for nonaqueous-electrolyte secondary battery. The positive-electrodeactive-material layer is made by binding a positive-electrode active material together with a binding agent. FIG. 1 shows a schematic diagram explaining a positive electrode for nonaqueous-electrolyte secondary battery according to one of the present examples. As illustrated in FIG. 1, a film 2 is formed on the surface of a current-collector body 1, and a positive-electrode active-material layer 3 is then formed on the surface of the film 2. In the present example, the current-collector body 1 with the film 2 formed is referred to as a positive-electrode current collector 4 for nonaqueous-electrolyte secondary battery.

The aforementioned positive-electrode active-material layer 3 is also allowed to further include a conductive additive. The positive electrode is formable as described below. A composition for forming the positive-electrode active-material layer is prepared: the composition includes a positive-electrode active material and a binding agent, as well as a conductive additive, if needed. In addition, the composition is turned into a paste-like substance by adding a proper solvent thereto. Then, the paste-like substance is coated onto a surface of the film on the positive-electrode current collector for nonaqueous-electrolyte secondary battery. Thereafter, the paste-like substance is dried. Thus, the positive-electrode active-material layer is formed. If needed, the positive-electrode active-material layer is compressed in order to enhance the density of the positive electrode.

As for a method of coating the composition for forming the positive-electrode active-material layer, publicly-known conventional methods, such as roll coating methods, dip coating methods, doctor blade methods, spray coating methods and curtain coating methods, are allowed to use.

As a solvent for viscosity adjustment, N-methyl-2-pyrrolidone (or NMP), methanol, methyl isobutyl ketone (or MIBK), and the like, are employable.

As for the positive-electrode active material, a lithium-containing compound being able to be used under high voltages is appropriate. For example, lithium-containing metallic composite oxides, and the like, such as lithium/cobalt composite oxides, lithium/nickel composite oxides and lithium/manganese composite oxides, are usable. Moreover, as the positive-electrode active material, another metallic compound, or a polymeric material is also usable. As for the other metallic compound, the following are given, for instance: oxides such as titanium oxide, vanadium oxide and manganese dioxide, or disulfides such as titanium sulfide and molybdenum sulfide. As for the polymeric material, conductive polymers, such as polyaniline or polythiophene, are given.

An especially preferable positive-electrode active material is composed of a composite metallic oxide expressed by a general formula: LiCoₚNi_{q}MnᵣDₛO₂ (where “D” is a doped component, and is at least one member selected from the group consisting of Al, Mg, Ti, Sn, Zn, W, Zr, Mo, Fe, and Na; “p”+“q”+“r”+“s”=1; 0≦“p”≦1; 0≦“q”≦1; 0≦“r”≦1; and 0≦“s”<1). Note herein that the aforementioned “p,” “q,” and “r” are preferably set in such a range as 0<“p”<1, 0<“q”<1, and 0<“r”<1, respectively. Since the aforementioned composite metallic oxides excel in the thermal stability and are low in cost, using the aforementioned composite metallic oxides in the positive-electrode active material results in the present nonaqueous-electrolyte secondary battery with thermal stability and inexpensive price.

As for the aforementioned composite metallic oxide, the following are usable, for instance: LiCo_{1/3}Ni_{1/3}Mn_{1/3}O₂, LiNi_{0.6}CO_{0.2}Mn_{0.2}O₂, LiNi_{0.5}Co_{0.2}Mn_{0.3}O₂, LiCoO₂, LiN_{0.8}Co_{0.2}O₂, or LiCoMnO₂. Among the composite metallic oxides, LiCo_{1/3}Ni_{1/3}Mn_{1/3}O₂, or LiNi_{0.5} CO_{0.2}Mn_{0.3}O₂ is preferable in terms of the thermal stability.

The binding agent performs a role of fastening the positive-electrode active material and conductive additive together onto the positive-electrode current collector. As the binding agent, the following are usable, for instance: fluorine-containing resins, such as polyvinylidene fluoride, polytetrafluoroethylene and fluorinated rubber; thermoplastic resins, such as polypropylene, polyethylene and polyvinyl acetate-based resins; imide-based resins, such as polyimide and polyamide-imide; and alkoxysilyl group-containing resins; as well as rubbers, such as styrene-butadiene rubber (or SBR).

The conductive additive is added in order to enhance the electrically-conducting property of an electrode. As the conductive additive, the following are addable independently, or two or more of the following are combinable to add: carbonaceous fine particles, such as carbon black, graphite, acetylene black (or AB) and KETJENBLACK (or KB (registered trademark)); and gas-phase-method carbon fibers (or VGCF). Although an employment amount of the conductive additive is not at all restrictive especially, setting the employment amount is possible at from 1 to 30 parts by mass approximately with respect to 100-part-by-mass active materials to be contained in the positive electrode, for instance.

### Nonaqueous-Electrolyte Secondary Battery

In addition to the above-mentioned positive electrode for nonaqueous-electrolyte secondary battery according to the present invention, the nonaqueous-electrolyte secondary battery according to the present invention further comprises a negative electrode, a separator, and an electrolyte using LiPF₆ serving as an electrolytic salt, as the battery constituent elements.

The negative electrode comprises a current collector, and a negative-electrode active-material layer bound onto a surface of the current collector. The negative-electrode active-material layer includes a negative-electrode active material, and a binding agent, as well as a conductive additive, if needed. The current collector, the binding agent, and the conductive additive are the same as the current-collector body, binding agent and conductive additive described in the positive electrode.

As for the negative-electrode active material, the following are usable: carbon-based materials being capable of occluding and releasing (or sorbing and desorbing) lithium; elements being capable of alloying with lithium; element compounds comprising an element being capable of alloying with lithium; or polymeric materials.

As for the carbon-based material, the following are given: non-graphitizable carbon, artificial graphite, cokes, graphites, glassy carbons, organic-polymer-compound calcined bodies, carbon fibers, activated carbon, or carbon blacks. Note herein that the “organic-polymer-compound calcined bodies” refer to calcined bodies carbonized by calcining polymeric materials, such as phenols and furans, at a proper temperature.

An allowable element being capable of alloying with lithium is at least one member selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. Even among the elements, silicon (Si), or tin (Sn) is preferable as for the element being capable of alloying with lithium.

As for the element compound comprising an element being capable of alloying with lithium, the following are employable, for instance: ZnLiAl, AlSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, Ni₂Si₂, NbSi₂, TaSi₂, VSi₂, WSi₂, ZnSi₂, SiC, Si₃N₄, Si₂N₂O, SiOᵥ (where 0<“v”≦2), SnO_{w} (where 0<“w” 2), SnSiO₃, LiSiO, or LiSnO. As for the element compound comprising an element being capable of alloying with lithium, a silicon compound, or a tin compound is preferable. As for the silicon compound, SiOₓ (where 0.5≦“x”≦1.5) is preferable. As for the tin compound, tin alloys (such as Cu—Sn alloys and Co—Sn alloys) are employable.

As for the polymeric material, polyacetylene or polypyrrole, and the like, is employable.

The separator is one of the constituent elements making lithium ions pass therethrough while isolating the positive electrode and negative electrode from one another and preventing the two electrodes from contacting with each other to result in electric-current short-circuiting. As the separator, the following are employable, for instance: porous membranes made of synthetic resins, such as polytetrafluoroethylene, polypropylene, or polyethylene; or porous membranes made of ceramics.

In addition to using LiPF₆ to serve as an electrolytic salt, an electrolyte being usable for common nonaqueous-electrolyte secondary battery is employable as the electrolyte. The electrolyte includes a solvent, and an electrolytic salt dissolved in the solvent.

As the solvent, cyclic esters, linear or chain-shaped esters, and ethers are employable, for instance. As the cyclic esters, the following are employable, for instance: ethylene carbonate, propylene carbonate, butylene carbonate, gamma-butyrolactone, vinylene carbonate, 2-methyl-gamma-butyrolactone, acetyl-gamma-butyrolactone, and gamma-valerolactone. As the linear esters, the following are employable, for instance: dimethyl carbonate, diethyl carbonate, dibutyl carbonate, dipropyl carbonate, methyl ethyl carbonate, alkyl propionate ester, dialkyl malonate ester, and alkyl acetate ester. As the ethers, the following are employable, for instance: tetrahydrofuran, 2-methyltetrahydrofuran, 1,4-dioxane, 1,2-dimethoxyethane, 1,2-diethoxyethane, and 1,2-dibutoxyethane.

Moreover, as the electrolytic salt, the LiPF₆ is employed. Since the LiPF₆ has high conductivity, reducing the internal resistance of a lithium-ion secondary battery using the LiPF₆ as an electrolytic salt is possible.

As the electrolyte, the following solution is employable: a solution comprising the LiPF₆ dissolved in a concentration of from 0.5 mol/L to 1.7 mol/L approximately in a solvent, such as ethylene carbonate, dimethyl carbonate, propylene carbonate or diethyl carbonate, for instance.

Since the nonaqueous-electrolyte secondary battery according to the present invention comprises the aforementioned positive electrode for nonaqueous-electrolyte secondary battery, and the electrolyte including the LiPF₆ serving as an electrolytic salt, the present nonaqueous-electrolyte secondary battery exhibits superior rate characteristic and cyclability.

The aforementioned nonaqueous-electrolyte secondary battery is available for being mounted in a vehicle. Since the aforementioned nonaqueous-electrolyte secondary battery exhibits large charged and discharged capacities, and since the nonaqueous-electrolyte secondary battery enables the superior rate characteristic and cyclability to be compatible with each other, a vehicle having the nonaqueous-electrolyte secondary battery on-board is of high performance in terms of the output and longevity.

As for the vehicle, an allowable vehicle is a vehicle making use of electric energies produced by battery for all or some of the power source. For example, the following are given: electric automobiles, hybrid automobiles, plug-in hybrid automobiles, hybrid railroad vehicles, electric-powered forklifts, electric wheelchairs, electric-power-assisted bicycles, and electric-powered two-wheel vehicles.

Having been described so far are the embodiment modes of the nonaqueous-electrolyte secondary battery according to the present invention. However, the present invention is not limited to the aforementioned embodying modes. The present invention is feasible in various modes, to which changes or modifications that one of ordinary skill in the art carries out are made, within a range not departing from the gist of the present invention.

### EXAMPLES

The present invention is hereinafter described more concretely, while giving Examples thereof.

### Forming of Film onto Current Collector

As the current collector, an aluminum foil with 20-μm thickness was readied. As the binder for film, polyvinylidene fluoride (or PVDF) was readied. As the SnO₂, an SnO₂ powder with 30-nm average particle diameter was readied. As the conductive carbon material, acetylene black (or AB) was readied. Moreover, as the solvent for viscosity adjustment, N-methyl-2-pyrrolidone (or NMP) was readied.

### Current Collector “A”

The SnO₂ powder, and the AB were mixed one another so as to make a ratio, 75:25 by mass, by a ball-milling apparatus, thereby preparing a first mixture. The first mixture, and the PVDF were mixed one another so as to make a ratio, 3:1 by mass, and were then dissolved in the NMP so as to make a fraction of the solid content 20%, thereby obtaining a first slurry. The first slurry was coated onto the aluminum foil using a doctor blade method, was then dried at 120° C., thereby forming a film having 100-nm thickness on the aluminum foil. The thus prepared part was labeled Current Collector “A.”

### Current Collector “B”

Other than using, instead of the first mixture, a second mixture in which the SnO₂ powder and AB made a ratio, 50:50 by mass, Current Collector “B” was prepared in the same manner as Current Collector “A.”

### Current Collector “C”

Other than using, instead of the first mixture, a third mixture in which the SnO₂ powder and AB made a ratio, 25:75 by mass, Current Collector “C” was prepared in the same manner as Current Collector “A.”

### Current Collector “D”

Other than using, instead of the first mixture, the SnO₂ powder alone, Current Collector “D” was prepared in the same manner as Current Collector “A.”

### Current Collector “E”

Other than using, instead of the first mixture, the AB alone, Current Collector “E” was prepared in the same manner as Current Collector “A.”

### Current Collector “F”

Other than the following: using, instead of the PVDF, polytetrafluoroethylene (or PTFE) as the binder for film; and using, instead of the NMP, ion-exchanged water as the solvent for viscosity adjustment, Current Collector “F” was prepared in the same manner as Current Collector “D.”

### Fabricating of Laminated-Type Lithium-Ion Secondary Battery

### First Example

A laminated-type lithium-ion secondary battery according to First Example using Current Collector “A” as the current collector for positive electrode was fabricated as described below. First of all, LiNi_{0.5}CO_{0.2}Mn_{0.3}O₂ serving as a positive-electrode active material, acetylene black serving as a conductive additive, and polyvinylidene fluoride (or PVDF) serving as a binding agent were set up in such an amount as 88 parts by mass, 6 parts by mass and 6 parts by mass, respectively, and were then mixed one another. The mixture was dispersed in a proper amount of N-methyl-2-pyrrolidone (or NMP), thereby preparing a slurry.

The slurry was put on the aforementioned Current Collector “A,” and was then coated onto the Current Collector “A” using a doctor blade so as to turn the slurry into a film shape. After drying the thus obtained sheet at 80° C. for 20 minutes to remove the NMP by volatilization, the Current Collector “A,” and the coated substance on the Current Collector “A” were firmly adhesion joined by a roll pressing machine. On the occasion, the electrode density was set so as to be 12 g/cm³. The thus joined substance was heated at 120° C. for 6 hours with a vacuum drier, and was then cut out to a predetermined configuration (e.g., a rectangular shape with 25 mm×30 mm), thereby making a positive electrode 1 with a thickness of about 50 μm.

A negative electrode was made in the following manner. The following were mixed one another: 97 parts by mass of a graphite powder; 1 part by mass of acetylene black serving as a conductive additive; and 1 part by mass of styrene-butadiene rubber (or SBR) and 1 part by mass of carboxymethylcellulose (or CMC), the two serving as a binding agent. The mixture was dispersed in ion-exchanged water, thereby preparing a slurry. The slurry was coated onto a copper foil with 20-μm thickness serving as a current collector for negative electrode using a doctor blade so as to turn the slurry into a film shape. After drying the current collector with the slurry coated, the current collector was pressed. The thus joined substance was heated at 120° C. for 6 hours with a vacuum drier, and was then cut out to a predetermined configuration (e.g., a rectangular shape with 25 mm×30 mm), thereby making a negative electrode with 45-μm thickness approximately.

Using the above-mentioned positive electrode 1 and negative electrode, a laminated-type lithium-ion secondary battery was fabricated. Specifically, a rectangle-shaped sheet serving as a separator and composed of a polypropylene resin with 27×32 mm in size and 25 μm in thickness was interposed or held between the positive electrode 1 and the negative electrode, thereby making a polar-plate subassembly. After covering the polar-plate subassembly with laminated films in which two pieces made a pair and then sealing the laminated films at the three sides, an electrolytic solution was injected into the laminated films which had been turned into a bag shape. As the electrolytic solution, a solution was used: the solution comprised a solvent in which ethylene carbonate (or EC), and diethyl carbonate (or DEC) had been mixed one another in such a ratio as EC:DEC=3:7 by volume; and 1-mol LiPF₆ dissolved in the solvent. Thereafter, the remaining one side was sealed, thereby obtaining a laminated-type lithium-ion secondary battery in which the four sides were sealed air-tightly and in which the polar-plate subassembly and electrolytic solution were closed hermetically. Note that the positive electrode and negative electrode were equipped with a tab connectable electrically with the outside, respectively, and the tabs extended out partially to the outside of the laminated-type lithium-ion secondary battery. The laminated-type lithium-ion secondary battery according to First Example was fabricated through the above steps.

### Second Example

Other than using the Current Collector “B” instead of the Current Collector “A” in First Example, a laminated-type lithium-ion secondary battery according to Second Example was fabricated in the same manner as First Example.

### Third Example

Other than using the Current Collector “C” instead of the Current Collector “A” in First Example, a laminated-type lithium-ion secondary battery according to Third Example was fabricated in the same manner as First Example.

### First Comparative Example

Other than using the Current Collector “D” instead of the Current Collector “A” in First Example, a laminated-type lithium-ion secondary battery according to First Comparative Example was fabricated in the same manner as First Example.

### Second Comparative Example

Other than using the Current Collector “E” instead of the Current Collector “A” in First Example, a laminated-type lithium-ion secondary battery according to Second Comparative Example was fabricated in the same manner as First Example.

### Third Comparative Example

Other than using the Current Collector “F” instead of the Current Collector “A” in First Example, a laminated-type lithium-ion secondary battery according to Third Comparative Example was fabricated in the same manner as First Example.

### Evaluation of Rate Characteristic

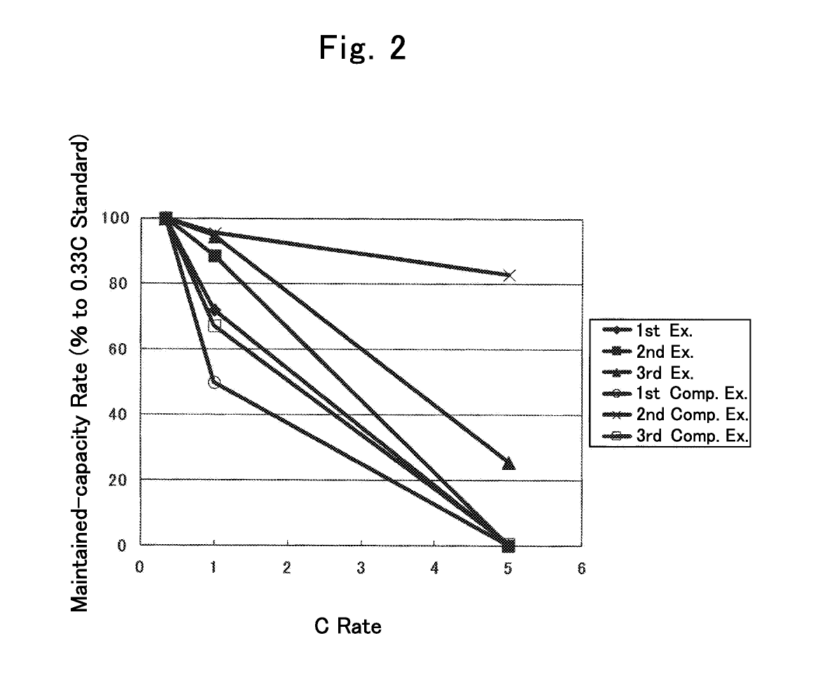

The rate characteristics of the laminated-type lithium-ion secondary batteries according to First Example, Second Example, Third Example, First Comparative Example, Second Comparative Example and Third Comparative Example were measured, respectively, at 25° C. The voltage range was set within a range of from 4.5 V to 3.0 V, and the current rate at which the batteries were discharged for 1 hour was labeled 1 C. Discharged capacities of the batteries were measured when a current rate was 0.33 C, 1 C and 5 C. The capacity when the current rate was 0.33 C was taken as a standard, and then proportions, namely, (the 1 C capacity)/(the 0.33 C capacity) and (the 5 C capacity)/(the 0.33 C capacity), were displayed by percentage. The results are shown in FIG. 2.

As being noticed in FIG. 2, the capacities declined in any of the laminated-type lithium-ion secondary batteries when the current rates became high; however, the rate characteristic was high in the following order when the capacities at the rate of 1 C were compared one another: Second Comparative Example>Third Example>Second Example>First Example>Third Comparative Example>First Comparative Example. The result represented that the greater the mixed proportion of the acetylene black (or AB) is, the higher the rate characteristic is. Moreover, from the results of First Comparative Example and Third Comparative Example, common materials, such as PVDF and PTFE, were understood to be selectable at will for the binder for film. From FIG. 2, compared with the laminated-type lithium-ion secondary battery according to First Comparative Example, the laminated-type lithium-ion secondary batteries according to First Example, Second Example and Third Example were found out to exhibit capacities being maintainable even at high rates, and the capacities were therefore inhibited from declining. The result found out that including the conductive carbon material in the film has an advantageous effect of inhibiting the flow of electrons from being obstructed in the surface of a current collector even at high rates. Moreover, the advantageous effect was found out to be remarkable as a rate became high.

### Evaluation of Cyclability

The cyclabilities of the laminated-type lithium-ion secondary batteries according to First Example, Second Example, Third Example, First Comparative Example, Second Comparative Example and Third Comparative Example were evaluated, respectively. A cycle test during which charging and discharging operations were repeated under the following conditions was carried out to measure discharged capacities at predetermined cycles, respectively. Upon charging, CC charging (i.e., constant-current charging) was done with a voltage of 4.5 V at a rate of 1 C at 25° C. Upon discharging, CC discharging (i.e., constant-current discharging) was carried out with 3.0 V at a rate of 1 C. The charging and discharging operations were labeled one cycle, and were repeated up to 50 cycles. First-round-cycle discharged capacities were taken as a standard, respectively, and thereby maintained-capacity rates were calculated. The maintained-capacity rates were found in predetermined cycles, respectively, by the following equation.

Maintained-capacity Rate (%)={(Discharged Capacity at Each Cycle)/(First-round Discharged Capacity)}×100

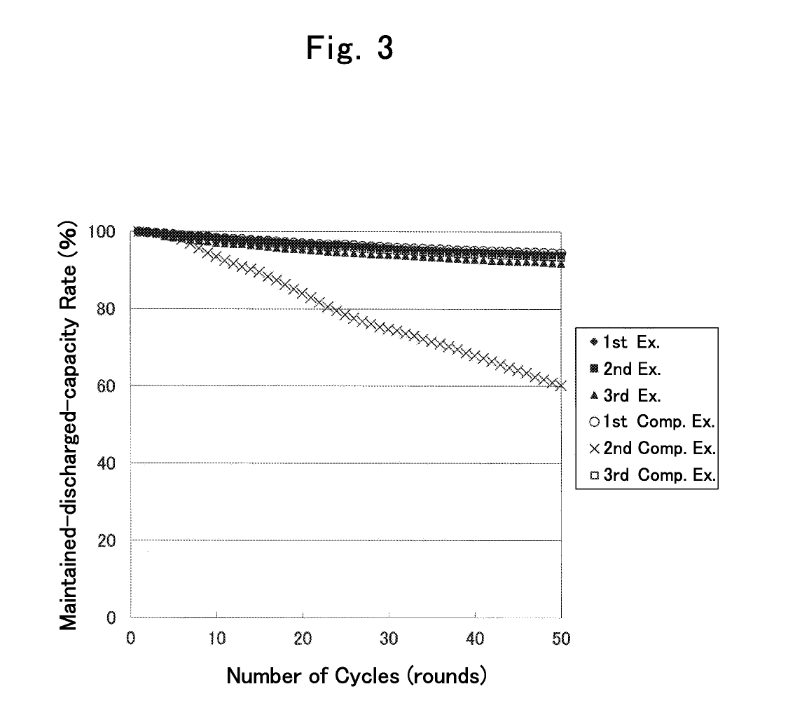

FIG. 3 shows the results of finding the cyclabilities of the laminated-type lithium-ion secondary batteries according to First Example, Second Example, Third Example, First Comparative Example, Second Comparative Example and Third Comparative Example.

From the results shown in FIG. 3, the cyclability of Second Comparative Example was found out to be poor. Moreover, all of First Example, Second Example and Third Example had better cyclabilities than the cyclability of Second Comparative Example, and substantially equivalent characteristics to each other were obtainable in First through Third Examples. Regarding Third Example of which the proportion of the SnO₂ was small, a slight decline in the cyclability was more noticeable than was in First Example and Second Example. Since the SnO₂ had high corrosion resistance and high oxidation resistance, including the SnO₂ in the film was believed to upgrade the cyclabilities. Moreover, insomuch as the proportion of the SnO₂ was high, the cyclabilities were found out to upgrade more.

From the results of finding the rate characteristics, and from the results of finding the cyclabilities, the laminated-type lithium-ion secondary batteries according to First through Third Examples were found out to excel in both of the rate characteristic and cyclability even under high-voltage application environments.

Moreover, the following were found out: forming the aforementioned film on the current-collector body leads to making the LiPF₆ (i.e., lithium hexafluorophosphate), which has been employed extensively as an electrolytic salt in lithium-ion secondary batteries having been available commercially heretofore, employable even under high-voltage application environments; and the forming results in making nonaqueous-electrolyte secondary batteries superior in the rate characteristics and cyclabilities.

1. A nonaqueous-electrolyte secondary battery comprising:
a positive-electrode current collector for nonaqueous-electrolyte secondary battery, the positive-electrode current collector including: a current-collector body; and a film formed on a surface of the current-collector body, and composed of SnO₂, a conductive carbon material and a binder for film; and
a nonaqueous electrolyte containing LiPF₆ (i.e., lithium hexafluorophosphate) as an electrolytic salt.

2. The nonaqueous-electrolyte secondary battery as set forth in claim 1, wherein a mixed ratio between said SnO₂ and said conductive carbon material is from 75:25 to 25:75 by mass.

3. The nonaqueous-electrolyte secondary battery as set forth in claim 1 further comprising a positive-electrode active material including a composite metallic oxide expressed by a general formula: LiCoₚNi_{q}MnᵣDₛO₂ (where “D” is a doped component, and is at least one member selected from the group consisting of Al, Mg, Ti, Sn, Zn, W, Zr, Mo, Fe, and Na; “p”+“q”+“r”+“s”=1; 0≦“p”≦1; 0≦“q”≦1; 0≦“r”≦1; and 0≦“s”<1).

4. The nonaqueous-electrolyte secondary battery as set forth in claim 1, wherein a thickness of said film is from 100 nm to 1 μm.
